(19) United States
(12) Patent Application Publication
(10) Pub. No.: US 2017/0163877 A1
(43) Pub. Date: Jun. 8, 2017

(54) METHOD AND ELECTRONIC DEVICE FOR PHOTO SHOOTING IN BACKLIGHTING SCENE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Xuefeng Zhao, Beijing (CN); Li Li, Beijing (CN)

(21) Appl. No.: 15/243,424

(22) Filed: Aug. 22, 2016

Related U.S. Application Data
(63) Continuation of application No. PCT/CN2016/088970, filed on Jul. 6, 2016.

(30) Foreign Application Priority Data
Dec. 8, 2015 (CN) 201510898033.7

(51) Int. Cl. H04N 5/232; H04N 5/235; G06K 9/00; G06K 9/62

(52) U.S. Cl. CPC H04N 5/23216; G06K 9/6269; H04N 5/2355; H04N 5/2351; G06K 9/00664

(57) ABSTRACT

Embodiments of the present disclosure disclose a method and electronic device for photo shooting in backlighting scene. The method includes: detecting real-time environmental parameters for photo shooting; performing backlighting scene identification according to the real-time environmental parameters; performing auxiliary processing of shooting for backlighting scene according to the identification result. The photo shooting method and electronic device for backlighting scene provided in embodiments of the present disclosure simplify the startup process of the auxiliary processing for backlighting scene.

### CROSS-REFERENCES TO RELATED APPLICATIONS

The application is a continuation application of a PCT application No. PCT/CN2016/088970, filed on Jul. 6, 2016, which claims the priority of Chinese Patent Application No. 201510898033.7, titled “Method and Device For Photo Shooting In Backlighting Scene”, filed to the State Intellectual Property Office of China (SIPO) on Dec. 8, 2015, the entire content of both applications is incorporated herein by reference.

### TECHNICAL FIELD

Embodiments of the present disclosure relate to the technical field of smart terminals, for example, to a method and an electronic device for photo shooting in backlighting scene.

### BACKGROUND

With the popularity of digital cameras and various mobile terminals equipped with camera heads, taking digital photos has been common in people's life.

When shooting digital photos, people often encounter the situation of backlighting of the target to be shot. The photos taken in this case often have a greatly reduced quality of images due to loss of the details of highlight parts or dark parts of images therein. The above problems can be addressed better if a high dynamic range (HDR) shooting mode is employed.

Nonetheless, in the related art, man-made judgment and setting as to whether to start up the HDR shooting mode are needed. That is, users with the shooting device will start up the HDR shooting mode manually only when they feel necessary to do so according to their personal experiences. Thus, not only deviation of the judgment as to whether to start up the HDR shooting mode may be present, but also the enabling process is complex.

In the related art, the HDR shooting mode can also be started up according to the judgment for scene, and a general scene judging method is to make an analysis based on the brightness histogram for a preview image, so as to decide that whether it is a backlighting scene. However, due to the inherent complexity of the backlighting scene, the simple decision method based on the brightness histogram would have considerable shortcomings of misjudgment and missing.

### SUMMARY

In view of this, embodiments of the present disclosure are to propose a method and an electronic device for photo shooting in backlighting scene, which can simplify the startup process of auxiliary processing for backlighting scene, enhancing the accuracy for scene judgment.

In a first aspect, embodiments of the present disclosure provide a method for photo shooting in backlighting scene, the method includes: detecting real-time environmental parameters for photo shooting; performing backlighting scene identification according to the real-time environmental parameters; and performing auxiliary processing of shooting for backlighting scene according to the identification result.

In a second aspect, embodiments of the present disclosure also provide an electronic device for photo shooting in backlighting scene, the electronic device includes: at least one processor; and a memory communicably connected with the at least one processor for storing instructions executable by the at least one processor, wherein execution of the instructions by the at least one processor causes the at least one processor to: detect real-time environmental parameters for photo shooting; perform backlighting scene identification according to the real-time environmental parameters; and perform auxiliary processing of shooting for backlighting scene according to the identification result.

In a third aspect, embodiments of the present disclosure provide a non-transitory computer-readable storage medium storing executable instructions that, when executed by an electronic device, cause the electronic device to: detect real-time environmental parameters for photo shooting; perform backlighting scene identification according to the real-time environmental parameters; and perform auxiliary processing of shooting for backlighting scene according to the identification result.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of the method for photo shooting in backlighting scene provided in some embodiments of the present disclosure;

FIG. 2 is a flow chart of scene identification in the method for photo shooting in backlighting scene provided in some embodiments of the present disclosure;

FIG. 3 is a flow chart of confidence determination in the scene identification provided in some embodiments of the present disclosure;

FIG. 4 is a flow chart of backlighting identification in the scene identification provided in some embodiments of the present disclosure;

FIG. 5 is a flow chart of the method for photo shooting in backlighting scene provided in some embodiments of the present disclosure;

FIG. 6 is a structural diagram of the electronic device for photo shooting in backlighting scene provided in some embodiments of the present disclosure; and

FIG. 7 is a functional block diagram of the hardware structure of a terminal provided in embodiments of the present disclosure.

### DETAILED DESCRIPTION

Below the present disclosure is further described in details with reference to the accompanying drawings and the embodiments. It can be understood that the embodiments described herein are merely used for explaining, rather than limiting, the present disclosure. Additionally, it should be noted that, for the convenience of description, only part but not all of the contents associated with the present disclosure is shown in the accompanying drawings.

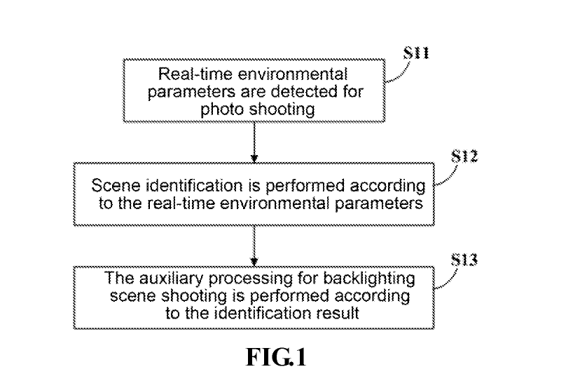

FIG. 1 is a flow chart of the method for photo shooting in backlighting scene provided in some embodiments of the present disclosure. The embodiment can be used in backlighting scene for which the photos are shot by a shooting device.

Referring to FIG. 1, the method for photo shooting in backlighting scene includes: Step S11, Step S12, and Step S13.

In Step S11, real-time environmental parameters are detected for photo shooting.

It can be understood that, when shooting photos using a digital camera or a mobile terminal, the environment where the digital camera or the mobile terminal is located can be characterized by real-time environmental parameters. The real-time environmental parameters may include: time information, time zone information, global location position information, weather condition information, and terminal azimuth information, etc. The real-time environmental parameters are the parameter data which can be acquired by the digital camera or the mobile terminal. Manners for acquiring the real-time environmental parameters include performing an acquisition through a sensor in self-configuration, performing an acquisition from system parameters contained in the system, or performing an acquisition from a set service terminal through a network.

In Step S12, scene identification is performed according to the real-time environmental parameters.

After the real-time environmental parameters are acquired, it is identified according to the real-time environmental parameters whether the digital camera or the mobile terminal is in a backlighting scene upon photo shooting.

Optionally, the confidence that the digital camera or the mobile terminal is in a backlighting scene upon photo shooting can be evaluated according to the different acquired real-time environmental parameters, so that a corresponding confidence can be obtained, and then, it can be decided whether they are in a backlighting scene upon photo shooting according to the confidence.

In addition, a support vector machine (SVM) classifier can be trained in advance for the real-time environmental parameters, and the classifier is utilized for classifying according to the real-time environmental parameters in order to decide whether the digital camera or the mobile terminal is in a backlighting scene upon shooting.

In Step S13, the auxiliary processing for backlighting scene shooting is performed according to the identification result.

In embodiment of the present disclosure, the auxiliary processing of shooting for backlighting scene includes: startup of a HDR shooting mode. In some embodiments, when it is identified that it is in a backlighting scene currently, the HDR shooting mode is started up, whereas when it is not in a backlighting scene currently, the action of starting up the HDR shooting mode is not performed.

In the present embodiment, by detecting the real-time environmental parameters for photo shooting, performing the backlighting scene identification according to the real-time environmental parameters and performing the auxiliary processing for backlighting scene shooting according to the identification result, the startup process of auxiliary processing for backlighting scene can be simplified, meanwhile, since the real-time environment parameter are incorporated, the accuracy for backlighting scene judgment can also be enhanced.

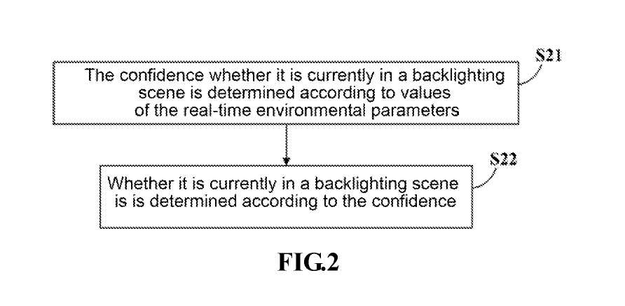

FIG. 2 is a flow chart of scene identification in the photo shooting method for backlighting scene provided in some embodiments of the present disclosure. The embodiment provides a technical solution for the scene identification in a photo shooting method for backlighting scene on basis of the above embodiment of the present disclosure. In the technical solution, performing the backlighting scene identification according to values of the real-time environmental parameters includes: determining the confidence that it is currently in a backlighting scene according to the real-time environmental parameters; and determining whether it is currently in a backlighting scene according to the confidence.

Referring to FIG. 2, performing the backlighting scene identification according to the real-time environmental parameters includes: Step S21 and Step S22.

In Step S21, the confidence that it is currently in a backlighting scene is determined according to values of the real-time environmental parameters.

Optionally, values of different types of real-time environmental parameters can be considered comprehensively to finally determine the confidence that it is in a backlighting scene.

Optionally, according to each type of real-time environmental parameter, a value of confidence of its corresponding type can be given, and the confidence data of respective type can be weighted and averaged to obtain a final confidence that it is in a backlighting scene.

In Step S22, whether it is currently in a backlighting scene is determined according to the confidence.

The confidence may be directly used for determining whether it is in a backlighting scene currently, and may also assist in other judgment manners for backlighting scene to finally determine whether it belongs to a backlighting scene. For example, a threshold for the decision manner based on a brightness histogram may be adjusted according to the confidence.

The embodiment determines the confidence that it is currently in a backlighting scene according to the values of the real-time environmental parameters and determines whether it is in a backlighting scene according to the confidence, thereby accurately determining whether it is in a backlighting scene.

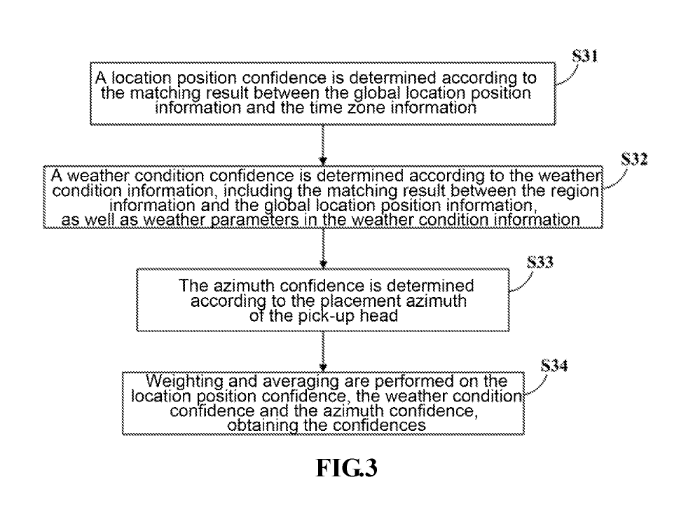

FIG. 3 is a flow chart of confidence determination in the scene identification provided in some embodiments of the present disclosure. The embodiment provides a technical solution for the confidence determination in scene identification on basis of the above embodiment of the present disclosure.

Referring to FIG. 3, determining the confidence that it is currently in a backlighting scene according to the values of the real-time environmental parameters includes: Steps S31-S34.

In Step S31, a location position confidence is determined according to the matching result between the global location position information and the time zone information.

If the global location position information can not be acquired for a period of time, then it is judged that possibly it is in an indoor environment or the like, so that a lower location position confidence would be imparted.

In the case that the global location position information can be obtained, the geographic position information is compared with the current time zone information of the mobile terminal, and if they are inconsistent significantly, then this judgment result is invalid, providing no location position confidence.

If the global location position information and the current time zone information of the mobile terminal are consistent, then the location position confidence is calculated according to the current geographic position information and the system date and hour of the mobile terminal, for example, definitively, a very low location position confidence is given in night, and a very high location position confidence is given in several hours before and after the midday, and a lower location position confidence is given to a time period which may be a few time elapse after the sunrise and a few time elapse before the sunset.

In Step S32, a weather condition confidence is determined, according to the matching result between the region information contained in the weather condition information and the global location position information, and weather parameters in the weather condition information.

Analyzing the real-time weather condition acquired by the mobile terminal, and if the region position corresponding to the pushed weather information is inconsistent with the global location position information, this judgment result is invalid, providing no weather condition confidence.

If the region position corresponding to the pushed weather information is consistent with the global location position information, then a backlighting environment confidence is calculated in light of the current real-time weather information, for example, a very low weather condition confidence is given if the current weather is a sleet or overcast day, a very high weather condition confidence is given when the current weather is a clear day, and a lower weather condition confidence is given when the current weather is in a cloudy state.

In Step S33, an azimuth confidence is determined according to the placement azimuth of pick-up head.

The handset placement azimuth provided by a position sensor on the mobile terminal is analyzed, and if the optical axis of the pick-up head is in an upward or downward direction, then a very low azimuth confidence is given; if the optical axis of the pick-up head is in a horizontal deflection downwardly, the a lower azimuth confidence is given; and if the optical axis of the pick-up head is in a horizontal direction or is in a horizontal deflection upwardly, the a higher azimuth confidence is given.

In Step S34, weighting and averaging are performed on the location position confidence, the weather condition confidence and the azimuth confidence, in order to obtain the confidence.

Optionally, weight coefficients of the location position confidence, the weather condition confidence and the azimuth confidence are determined respectively according to the decision as to the environment where the mobile terminal is, and then the above threes confidence parameters are weighted and averaged using the weight coefficients so as to obtain the final confidence parameter.

The weight coefficients of the three types of confidence parameters are determined self-adaptively according to the decision as to the environment where the mobile terminal is. For example, when it is decided that the mobile terminal is in an indoor environment, the weight coefficient of the weather condition confidence may be decreased properly, and values of the weight coefficients of the other two confidence parameters may be increased relatively. In the extreme case, weight coefficient(s) of one or two of the three confidence parameters may be set to zero, namely in the process of weighting and averaging, only the value(s) of the other one or two weight coefficient(s) may be considered.

The embodiment realizes the calculation of the confidence currently in a backlighting scene in a fuzzing mathematics manner by determining the location position confidence according to the matching result between the global location position information and the time zone information, determining the weather condition confidence according to the matching result between the region information included in the weather condition information and the global location position information as well as the weather parameters in the weather condition information, determining the azimuth confidence according to the placement azimuth of the pick-up head and performing weighting and averaging on the location position confidence, the weather condition confidence and the azimuth confidence to obtain the confidences.

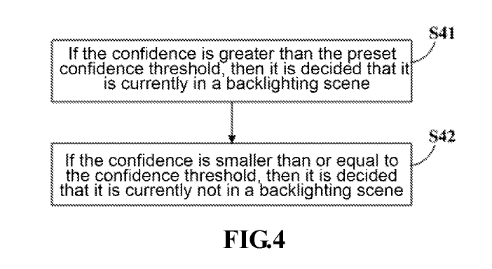

FIG. 4 is a flow chart of backlighting identification in the scene identification provided in some embodiments of the present disclosure.

Referring to FIG. 4, determining whether it is in a backlighting scene according to the confidence includes: Step S41 and Step S42.

In Step S41, it is decided that it is currently not in a backlighting scene if the confidence is smaller than the preset first confidence threshold.

If the value of the confidence is smaller than a preset first confidence threshold, then it means that the probability that the scene is a backlighting scene is extremely low, and it can be directly decided that the current scene is not a backlighting scene.

This operation is optional, and the confidence preferably assists in the other judgment manner for backlighting scene, but it can also be directly used for judging the backlighting scene.

In Step S42, the weighting ratio threshold between regions of different brightness are adjusted dynamically according to the confidence, and whether it is currently in a backlighting scene is decided according to the adjusted weighting ratio threshold, if the confidence is greater than or equal to the confidence threshold.

If the confidence is greater than or equal to the preset first confidence threshold, then whether it is in a backlighting scene cannot be decided directly according to the confidence parameter only, and the analysis for brightness histogram of images needs to be started up, to determine whether it is in a backlighting scene.

The analysis for the brightness histogram of image in the related art is mainly based on the decision as to whether it is in a backlighting scene mainly according to the weighting ratio between the highlight region and the medium-brightness region, and the weighting ratio between the dark region and the medium-brightness region. The weight ratio between the highlight region and the medium-brightness region refers to the ratio between the number of pixels of the highlight region and the number of pixels of the medium-brightness region. Correspondingly, the weight ratio between the dark region and the medium-brightness region refers to the ratio between the number of pixels of the dark region and the number of pixels of the medium-brightness region.

Optionally, if the weighting ratio between the highlight region and the medium-brightness region is greater than a first weighting ratio threshold, and the weighting ratio between the region part and the medium-brightness region is smaller than a second weighting ratio threshold, then it can be decided that it is in a backlighting scene. For example, if the weighting ratio between the highlight region and the medium-brightness region is greater than 4, and the weighting ratio between the dark region and the medium-brightness region is greater than 5, then it can be decided that it is currently in a backlighting scene.

It is noted that, in the analysis for brightness histogram of image in the related art, both of the thresholds of the weighting ratios are preset fixed value. The solution provided by the present embodiment is quite different in that values of the thresholds of the two weighting ratios can be adjusted dynamically according the confidence.

Optionally, adjusting dynamically the weighting ratio thresholds between regions of different brightness according to the confidence and deciding whether it is currently in a backlighting scene according to the adjusted weighting ratio threshold include:

decreasing the weighting ratio threshold between the regions of different brightness if the confidence is greater than or equal to the second confidence threshold, wherein the second confidence threshold is greater than the first confidence threshold;

increasing the weighting ratio threshold between the regions of different brightness if the confidence is smaller than the second confidence threshold; and

deciding whether it is currently in a backlighting scene according to the adjusted weighting ratio threshold.

That is, the first weighting ratio threshold and the second weighting ratio threshold may be decreased when the confidence has a high value; and the weighting ratio threshold and the second weighting ratio threshold may be increased when the confidence has a low value.

The aim of doing so is to make the decision result for the backlighting scene closer to the actual condition. Assume that a scene has a high confidence for backlighting scene, the threshold that the current scene is decided to be a backlighting scene may be decreased appropriately. And when a scene has a low confidence for backlighting scene, the threshold that the current scene is decided to be a backlighting scene may be increased appropriately.

For example, the real-time information of the current weather is overcast sky, and there is a low probability that backlight appears in a such environment, and in this case, the image brightness histogram needs to have characteristics of backlighting scene to a high degree so that the backlighting scene can be asserted, and the hence threshold needs to be turned up. On the other hand, the current information is a midday fine weather, there is a high probability that backlight appears in a such environment, and in this case, the brightness histogram of image only need to have characteristics of backlighting scene to a certain degree so that the backlighting scene can be asserted, and hence the threshold may be turned down.

The embodiment can assist in the backlighting scene judgment by incorporating the confidence of environmental parameters determination, enhancing the accuracy for backlight judgment, and can also perform the backlighting scene judgment directly by utilizing the confidence, simplifying the judging process.

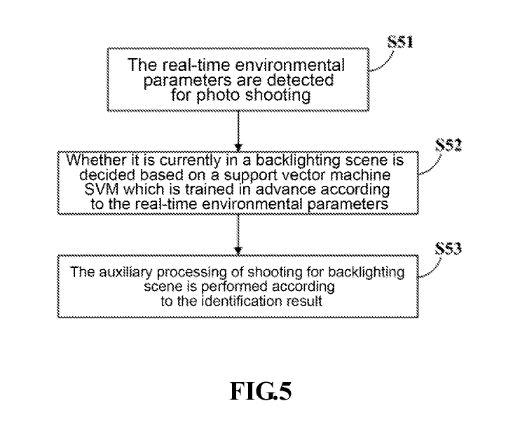

FIG. 5 is a flow chart of the photo shooting method for backlighting scene provided in some embodiments of the present disclosure. The embodiment provides a technical solution for the photo shooting method for backlighting scene on basis of the above embodiment of the present disclosure. In the technical solution, the photo shooting method for backlighting scene includes: detecting real-time environmental parameters for photo shooting;

deciding whether it is currently in a backlighting scene based on a support vector machine SVM which is trained in advance according to the real-time environmental parameters; and

performing auxiliary processing of shooting for backlighting scene according to the identification result.

Referring to FIG. 5, the photo shooting method for backlighting scene includes: Step S51, Step S52, and Step S53.

In Step S51, the real-time environmental parameters are detected for photo shooting.

In Step S52, whether it is currently in a backlighting scene is decided based on a support vector machine SVM which is trained in advance according to the real-time environmental parameters.

In the embodiment, a SVM classifier can be trained utilizing the training data, and when deciding whether it is in a backlighting scene currently, the SVM classifier trained in advance is employed to do this.

The input parameters of the SVM classifier are real-time environmental parameters acquired by the digital camera or the mobile terminal, and the output value of the SVM classifier is the decision result as to whether it is in a backlighting scene currently.

In Step S53, the auxiliary processing of shooting for backlighting scene is performed according to the identification result.

The auxiliary processing of shooting for backlighting scene refers to the startup of a HDR shooting mode.

The embodiment simplifies the startup process of the auxiliary processing for backlighting scene by detecting real-time environmental parameters for photo shooting, deciding whether it is currently in a backlighting scene based on a support vector machine SVM which is trained in advance according to the real-time environmental parameters, and performing the auxiliary processing of shooting for backlighting scene according to the identification result.

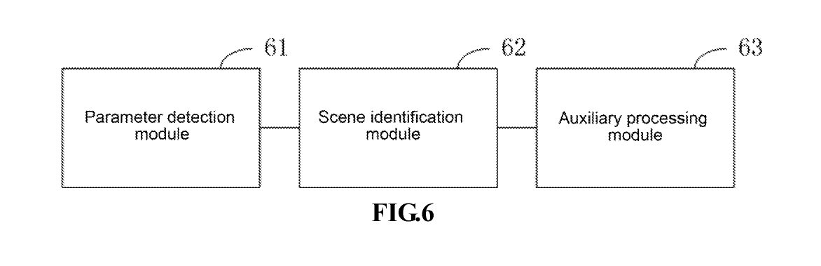

FIG. 6 is a structural schematic diagram of the electronic device for photo shooting in backlighting scene provided in some embodiments of the present disclosure. The embodiment provides a technical solution for the photo shooting device for backlighting scene. Referring to FIG. 6, in the technical solution, the photo shooting device for backlighting scene includes: a parameter detection module 61, a scene identification module 62, and a auxiliary processing module 63.

The parameter detection module 61 is configured for the detecting the real-time environmental parameters for photo shooting.

The scene identification module 62 is configured for performing backlighting scene identification according to the real-time environmental parameters.

The auxiliary processing module 63 is configured for performing auxiliary processing of shooting for backlighting scene according to the identification result.

Optionally, the real-time environmental parameters include at least one of time information, time zone information, global location position information, weather condition information, and terminal azimuth information.

Optionally, the scene identification module 62 includes: a confidence determining unit and a backlight identifying unit.

The confidence determining unit is configured for determining the confidence that it is currently in a backlighting scene according to values of the real-time environmental parameters.

The backlight identifying unit is configured for determining whether it is currently in a backlighting scene according to the confidence.

Optionally, the confidence determining unit is specifically configured for: determining the location position confidence according to the matching result between the global location position information and the time zone information; determining the weather condition confidence according to the matching result between the region information included in the weather condition information and the global location position information as well as the weather parameters in the weather condition information; determining the azimuth confidence according to the placement azimuth of the pick-up head; and performing weighing and averaging on the location position confidence, the weather condition confidence and the azimuth confidence, in order to obtaining the confidence.

Optionally, the backlight identifying unit is specifically configured for: if the confidence is greater than or equal to the first confidence threshold, then adjusting dynamically the weighting ratio threshold between regions of the different brightnesses according to the confidence, and deciding whether it is currently in a backlighting scene according to the adjusted weighting ratio threshold.

Optionally, the backlight identifying unit is further configured for: if the confidence is less than the preset first confidence threshold, deciding that it is currently not in a backlighting scene.

For the function of the backlight identifying unit for adjusting dynamically the weighting ratio threshold between regions of different brightness and deciding whether it is currently in a backlighting scene according to the adjusted weighting ratio threshold, it is configured for:

decreasing the weighting ratio threshold between regions of different brightness if the confidence is greater than or equal to the second confidence threshold, wherein the second confidence threshold is greater than the first confidence threshold;

increasing the weighting ratio threshold between regions of different brightness if the confidence is smaller than the second confidence threshold; and

deciding whether it is currently in a backlighting scene according to the adjusted weighting ratio threshold.

Optionally, the scene identification module includes: a SVM unit.

The SVM unit is configured for deciding whether it is currently in a backlighting scene based on a support vector machine SVM which is trained in advance according to the real-time environmental parameters.

The above photo shooting device for backlighting scene can perform the photo shooting method for backlighting scene provided by any embodiment of the present disclosure, having corresponding functional modules for performing the method and advantageous effects.

One skilled in the art should understand that the above-mentioned respective modules or respective steps of the present disclosure may be realized by a general computing device. They may be installed together on a single computer device or distributed in a network consisting of multiple computer devices. Optionally, they may be realized with the aid of executable program codes of computer devices. Thus, they may be stored in storage units and executed by computer devices. Alternatively, they may be realized by making them into integrated circuit modules respectively or making multiple modules or steps of them into a single integrated circuit module. In this way, the present disclosure is not limited to combinations of any specific software and hardware.

The above embodiments are all described in a progressive way, and each embodiment emphasizes on the difference from the other embodiments, and the same or like parts between respective embodiments can refer to each other.

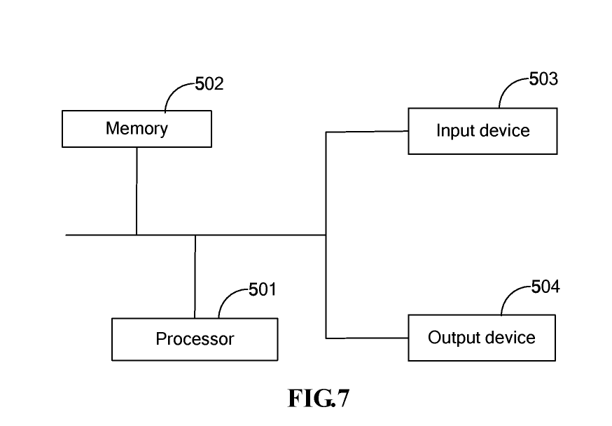

FIG. 7 is a functional block diagram of the hardware structure of a terminal (for example, a functional handset) provided in embodiments of the present application, as shown in FIG. 7, the terminal includes:

one or more processor(s) 501, and a memory 502, where one processor 501 is taken as an example in FIG. 7.

The terminal can also comprise an input device 503 and an output device 504.

The processor 501, the memory 502, the input device 503 and the output device 504 in the terminal can be connected through buses or in another manner, and buses are shown as an example in FIG. 7.

As an non-volatile computer-readable storage medium, the memory 502 can be used for storing non-volatile software programs, non-volatile computer executable programs and modules, such as the program instructions/modules corresponding to the photo shooting method for backlighting scene in embodiments of the present application (for example, the parameter detection module 61, the scene identification module 62, and the auxiliary processing module 63 shown in FIG. 6). The processor 501 executes various functional applications and data processing of the server by running non-volatile software programs, instructions and modules stored in the memory 502, namely, realizing the photo shooting method for backlighting scene.

The memory 502 can also comprise a program storage region and a data storage region, where the program storage region can store operating systems and application programs required by at least one function; and the data storage region can store the data created by using the shooting method for backlighting scene, etc. Moreover, the memory 502 can also comprise a high-speed Random Access Memory and also a non-volatile memory, such as at least one disc storage device, a flash memory device or other non-volatile solid state storage device. In some embodiments, the memory 502 optionally includes a memory located remotely relative to the processor 501.

The input device 503 may be configured to receive input digital or character information, user settings and key signal input related to the functional control. The output device 504 may include a display apparatus such as display screen, etc.

The one or more modules are stored in the memory 502, and when executed by the one or more processors 501, they will implement the photo shooting method for backlighting scene in any above method embodiment.

Embodiments of the present disclosure provide a non-transitory storage medium having computer executable instructions stored thereon, the computer executable instructions are configured to perform the method for photo shooting in backlighting scene in any embodiment of the present disclosure.

The embodiments above described herein are merely the embodiments of the present disclosure, which are not used for limiting the present disclosure. Various modifications and changes to these embodiments can be made by those skilled in the art. Within the spirit and principle of the present invention, any modifications, equivalent substitutions, improvements, etc., should fall into the scope of protection of the present invention.

What is claimed is:

1. A method for photo shooting in backlighting scene, executed by an electronic device, comprising:
detecting real-time environmental parameters for photo shooting;
performing backlighting scene identification according to the real-time environmental parameters; and
performing auxiliary processing of shooting for backlighting scene according to an identification result.

2. The method according to claim 1, wherein, the real-time environmental parameters comprise at least one of time information, time zone information, global location position information, weather condition information, and terminal azimuth information.

3. The method according to claim 2, wherein, detecting real-time environmental parameters for photo shooting comprises:
determining a confidence of a backlighting scene according to values of the real-time environmental parameters; and
determining whether a backlighting scene is currently present according to the confidence.

4. The method according to claim 3, wherein, determining the confidence of a backlighting scene according to values of the real-time environmental parameters comprises:
determining a location position confidence according to the matching result between the global location position information and the time zone information;
determining a weather condition confidence, according to the matching result between region information contained in the weather condition information and the global location position information, and weather parameters in the weather condition information;
determining an azimuth confidence according to the placement azimuth of the pick-up head; and
performing weighting and averaging on the location position confidence, the weather condition confidence and the azimuth confidence, to obtain the confidence.

5. The method according to claim 1, wherein, determining whether a backlighting scene is currently present according to the confidence comprises:
adjusting dynamically a weighting ratio threshold between regions of different brightness according to the confidence; and
deciding whether a backlighting scene is currently present according to the adjusted weighting ratio threshold, if the confidence is greater than or equal to the first confidence threshold.

6. The method according to claim 5, wherein, determining whether a backlighting scene is currently present according to the confidence further comprises:
determining that a backlighting scene is currently not present if the confidence is smaller than the preset first confidence threshold.

7. The method according to claim 5, wherein, adjusting dynamically the weighting ratio thresholds between regions of different brightness according to the confidence and deciding whether a backlighting scene is currently present according to the adjusted weighting ratio threshold comprise:
decreasing the weighting ratio threshold between the regions of different brightness if the confidence is greater than or equal to the second confidence threshold, wherein the second confidence threshold is greater than the first confidence threshold;
increasing the weighting ratio threshold between the regions of different brightness if the confidence is smaller than the second confidence threshold; and
deciding whether a backlighting scene is currently present according to the adjusted weighting ratio threshold.

8. The method according to claim 1, wherein, performing backlighting scene identification according to the real-time environmental parameters comprises:
deciding whether a backlighting scene is currently present based on a support vector machine SVM which is trained in advance according to the real-time environmental parameters.

9. An electronic device for photo shooting in backlighting scene, comprising:
at least one processor; and
a memory communicably connected with the at least one processor for storing instructions executable by the at least one processor, wherein execution of the instructions by the at least one processor causes the at least one processor to:
detect real-time environmental parameters for photo shooting,
perform backlighting scene identification according to the real-time environmental parameters, and
perform auxiliary processing of shooting for backlighting scene according to the identification result.

10. The electronic device according to claim 9, wherein, the real-time environmental parameters comprise: at least one of time information, time zone information, global location position information, weather condition information, and terminal azimuth information.

11. The electronic device according to claim 10, wherein, to perform backlighting scene identification according to the real-time environmental parameters, execution of the instructions by the at least one processor causes the at least one processor to:
determine a confidence that a backlighting scene is currently present according to values of the real-time environmental parameters; and
determine whether a backlighting scene is currently present according to the confidence.

12. The electronic device according to claim 11, wherein, to determine a confidence that a backlighting scene is currently present according to values of the real-time environmental parameters, execution of the instructions by the at least one processor causes the at least one processor to:
determine a location position confidence according to the matching result between the global location position information and the time zone information;
determine a weather condition confidence, according to the matching result between region information contained in the weather condition information and the global location position information, and weather parameters in the weather condition information; and
determine an azimuth confidence according to the placement azimuth of the pick-up head;
perform weighting and averaging on the location position confidence, the weather condition confidence and the azimuth confidence, to obtain the confidence.

13. The electronic device according to claim 9, wherein to determine whether a backlighting scene is currently present according to the confidence, execution of the instructions by the at least one processor causes the at least one processor to:
decide that a backlighting scene is currently present if the confidence is greater than the preset confidence threshold, wherein the value of the confidence threshold is determined according to the analysis for brightness histogram; and
decide that a backlighting scene is not currently present if the confidence is smaller than or equal to the confidence threshold.

14. The electronic device according to claim 13, wherein, to determine whether a backlighting scene is currently present according to the confidence, execution of the instructions by the at least one processor causes the at least one processor to:
decide that a backlighting scene is not currently present if the confidence is smaller than the preset first confidence threshold.

15. The electronic device according to claim 13, wherein, adjusting dynamically the weighting ratio thresholds between regions of different brightness according to the confidence and deciding whether a backlighting scene is currently present according to the adjusted weighting ratio threshold, execution of the instructions by the at least one processor causes the at least one processor to:
decrease the weighting ratio threshold between the regions of different brightness if the confidence is greater than or equal to the second confidence threshold, wherein the second confidence threshold is greater than the first confidence threshold;
increase the weighting ratio threshold between the regions of different brightness if the confidence is smaller than the second confidence threshold; and
decide whether a backlighting scene is currently present according to the adjusted weighting ratio threshold.

16. The electronic device according to claim 9, wherein, to perform backlighting scene identification according to the real-time environmental parameters, execution of the instructions by the at least one processor causes the at least one processor to:
decide whether a backlighting scene is currently present based on a support vector machine SVM which is trained in advance, according to the real-time environmental parameters.

17. The electronic device according to claim 10, wherein to determine whether a backlighting scene is currently present according to the confidence, execution of the instructions by the at least one processor causes the at least one processor to:
decide that a backlighting scene is currently present if the confidence is greater than the preset confidence threshold, wherein the value of the confidence threshold is determined according to the analysis for brightness histogram; and
decide that a backlighting scene is not currently present if the confidence is smaller than or equal to the confidence threshold.

18. The electronic device according to claim 11, wherein to determine whether a backlighting scene is currently present according to the confidence, execution of the instructions by the at least one processor causes the at least one processor to:
decide that a backlighting scene is currently present if the confidence is greater than the preset confidence threshold, wherein the value of the confidence threshold is determined according to the analysis for brightness histogram; and
decide that a backlighting scene is not currently present if the confidence is smaller than or equal to the confidence threshold.

19. The electronic device according to claim 12, wherein to determine whether a backlighting scene is currently present according to the confidence, execution of the instructions by the at least one processor causes the at least one processor to:
decide that a backlighting scene is currently present if the confidence is greater than the preset confidence threshold, wherein the value of the confidence threshold is determined according to the analysis for brightness histogram; and
decide that a backlighting scene is not currently present if the confidence is smaller than or equal to the confidence threshold.

20. A non-transitory computer-readable storage medium storing executable instructions that, when executed by an electronic device, cause the electronic device to:
detect real-time environmental parameters for photo shooting;
perform backlighting scene identification according to the real-time environmental parameters; and
perform auxiliary processing of shooting for backlighting scene according to the identification result.
